(19) United States
(12) Patent Application Publication
(10) Pub. No.: US 2009/0173678 A1
(43) Pub. Date: Jul. 9, 2009

(54) Vertical evaporation technologies

(76) Inventor: Clark Emory Lysne, Wetaskiwin (CA)

Correspondence Address: Clark Lysne, R.R. #5, Wetaskiwin, AB, T9A1X2, CA

(21) Appl. No.: 12/006,426

(22) Filed: Jan. 3, 2008

(51) Int. Cl. C02F 1/04; C02F 1/14

(52) U.S. Cl. 210/170.11

(57) ABSTRACT

This invention captures the salt from salt water in an easily transportable form. Most desalinators of the past were enclosed to capture the water vapour that escaped for the production of salt free water. They are enclosed which subtracted some of the suns energy. This invention has no enclosures. This invention can divide water into smaller units. This invention evaporates the water before it falls off the evaporating surface, thus having less water on the evaporating surface which makes evaporation easier. The surface tension of water is reduced by the small amounts of water on the evaporation cloths and with the use of water loving evaporation cloths. When water is dropped on cotton it wicks away and tries to equally distributes the water over its entire length and width. An equitable distribution of water to evaporation cloths is achieved by this invention. An ability to distribute water at various rates to an evaporation cloth in order to deal with the different evaporation rates of day or night or sunshine or cloud.

### FIELD OF THE INVENTION

The present invention relates to an apparatus for desalinating the water that is found in saline soils or saline bodies of water. The vertical evaporation of water reduces the effects of surface tension on the evaporation of water. Benefit will be derived by the capture of the salts and the evaporation of the saline water.

### BACKGROUND OF THE INVENTION

Elevated soil salt levels are a significant global agricultural and environmental concern and can lead to problems such as inhibited plant growth, plant death and problems with livestock consumption or no livestock consumption at all. Salt contamination of the subsurface water table which is used for human consumption maybe averted or reduced. Elevated salt levels can be caused by a number of factors including; high natural salt levels, industrial operations, mining operations, government operations, soil contamination from oil and gas removal, irrigation with water containing salts or other consequences of man's activities. The size of the bodies of saline water can be reduced or eliminated with the use this technology. Leaching from stock piles of salt or other substances could be controlled by subsurface drainage of leaching water. Current solutions to this problem include the addition of chemicals to the soil, the development of salt tolerant strains of plants, the physical removal and replacement of the affected soil, the physical removal of salty water, the use of membrane filters, the boiling of the water, the washing of salts into the subsoil and other methods. These options can be environmentally detrimental and are relatively expensive. Given that a significant portion of the global agricultural community operates under impoverished conditions, particularly in developing countries, there is a need for simple, environmentally friendly and inexpensive solution to this problem.

There are well known varying cultural methods of desalinating salt water for the purpose of obtaining fresh drinkable water. The object of this invention is the evaporation of the water and the capture of the salts or other chemicals that are dissolved in water or carried by water.

### SUMMARY OF THE INVENTION

The present invention is directed to an apparatus for the desalination of the salt water found in salty soils or salty ponds.

Accordingly, in one aspect of the invention, the invention comprises an apparatus comprising:
[a] a frame having vertical supports and a horizontal cross beam;
[b] an primary evaporation cloth attached to the cross beam;
[c] a distribution pipe for receiving salty water and depositing it evenly onto the primary evaporation cloth, the distribution pipe being attached to the frame in a position above the primary evaporation cloth;
[d] means for drawing water from the soil to the distribution pipe;
[e] means to regulate the volume of water deposited onto the primary evaporation cloth so that the water is evaporated before it falls off the bottom of the primary evaporation cloth leaving the salts at the bottom of the primary evaporation cloth;
[f] an avoidance of the effects of the surface tension of water by the vertical evaporation of water;
[g] an avoidance of the effects of the surface tension with the use of water wicking, water loving materials for the evaporation cloths;
[h] a salt container below the evaporation cloth;
[i] a frame having vertical supports which spans the salt container;
[j] a secondary evaporation cloth which is suspended from the frame over the salt container and touches the bottom of the salt container;
[k] the capture of the salts or dissolved substances in an easily transported form.

### A BRIEF DESCRIPTION OF THE DRAWINGS

FIG. 1 shows a desalinator unit. There is a windmill which can bring the salty water from its source to the reservoir on the top of the unit. The valve on the reservoir will deliver the salty water to the distribution pipe as it is required. The distribution pie will distribute the salty water evenly and at various rates to the primary evaporation cloths. The primary evaporation cloths in this example are two beach towels. The water is evaporated as it falls down the primary evaporation cloths leaving the salts at the bottom of the primary evaporation cloths. When an appropriate amount of salts have accumulated at the bottom of the cloths, they are washed off the primary evaporation cloths into the salt container. The salt container has secondary evaporation cloths which touch the bottom of the salt container. The secondary evaporation cloths wick the salty water up and evaporate this water leaving the salts at the top of the secondary evaporation cloth with an wet area below the salts. Newspapers can fulfill the functions of the secondary evaporation cloth. When salts have deposited on the newspapers to an optimum degree they can be taken to an appropriate landfill.

FIG. 2 shows the distribution pipe and the cross beam. It shows how the distribution pipe can distribute the salty water evenly and at various rates to the primary evaporation cloth.

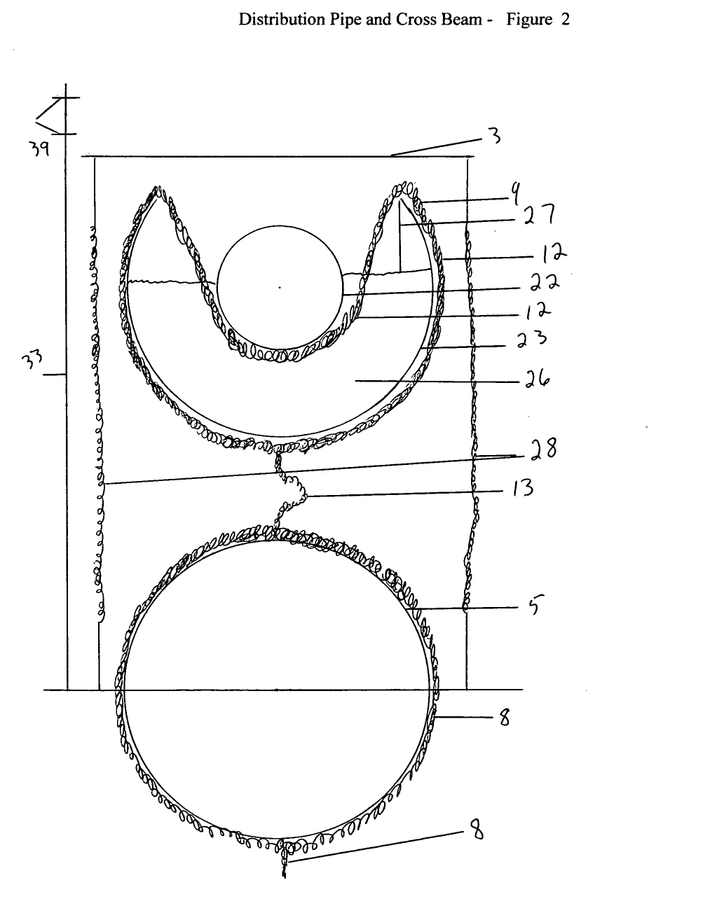

FIG. 3 show the valve in detail. The valve is connected to the cross beam. This connection is adjustable to allow the valve to open when the primary evaporation cloth has evaporated some of the water and can hold more salty water.

FIG. 4 shows how a series of desalinators can be installed. It shows how they can be installed on uneven terrain.

FIG. 5 shows the salt container The secondary evaporation cloths can be discarded newspapers. The salty water wicks up the newspaper and is deposited above the wet area on the newspaper. The newspaper with the salt crystals can be taken to an disposal site. FIG. 5 shows how a series of desalinators can be installed. It shows how they can be installed on uneven terrain.

FIG. 6 shows how the desalinators operate when electrical power is available. They also show weights sensors to open and close the valve. It shows a computer or other electrical equipment controlling the timing of the wash cycle and the controlling of the valve that puts water on the primary evaporation cloth.

### DETAILED DESCRIPTION OF THE INVENTION

The present invention is directed to an apparatus for the desalination of the salty water that is found in saline soils and saline pools.

The apparatus [1] according to FIG. [1] is comprised of a two posts [2] that have been installed in the ground on which a frame [3] has been attached which has vertical support members [4] and a horizontal cross beam [5] having a first end [6] and a second end [7]. The first end of the cross beam [6] is hingedly attached to the frame and the second end of the cross beam [7] is suspended on a spring or springs. The apparatus [1] has an primary evaporation cloth [8] that is attached to the cross beam [5]. Above the primary evaporation cloth [8] and the cross beam [5] is the distribution pipe [9] which is physically configured to deposit water evenly onto the primary evaporation cloth[8]. As shown in FIG. [1], the distribution pipe [9] is horizontally orientated. The distribution pipe [9] is fastened to the frame [3] at each end [10] and in the middle [10]. As depicted in FIG. [1], the primary evaporation cloth [8] will hang in a substantially vertical orientation, however it should be understood that the primary evaporation cloth [8] may be suspended in other orientations without impairing its functionality. In a preferred embodiment, the primary evaporation cloth [8] will be orientated in a north-south manner in order to maximize the sunlight received by each side of the primary evaporation cloth [8]. The water is evaporated and the salts [11] are deposited at the bottom of the primary evaporation cloth [8]. The water moves the salts down the primary evaporation cloth [8] until the salt water can no longer hold the salts in solution and salt crystals [11] appear and grow as the last of the water evaporates.

The temperature of the primary evaporation cloths [8] is below the temperature of the environment enabling the choice of many different types of primary evaporation cloths [8]. Glass fibres do not absorb water. This inventor prefers water loving materials. Beach towels are a suitable choice for use as the primary evaporation cloth [8], the distribution pipe evaporation cloth [12] and the connecting evaporation cloth [13]. The towel material is designed to absorb and evaporate water, these features are central to this invention. Cotton is a good material because it is hydrophilic, the fibres absorb water causing the fibres to swell. The water loving cotton spreads the saline water evenly across the surface and inside of the evaporation cloth fibres as they swell.

“Capillary action, capillarity, capillary motion, or wicking is the ability of a substance to draw another substance into it. The standard reference is to a tube in plants but can be seen readily with porous paper. It occurs when the adhesive intermolecular forces between the liquid and a substance are stronger than the cohesive intermolecular forces inside the liquid. The effect causes a concave meniscus to form where the substance is touching a vertical surface. The same effect is what causes porous materials such as sponges to soak up liquids.” [Wikipedia] “Surface Tension is an effect within the surface layer of a liquid that results in a behaviour analogous to an elastic sheet.” [Wikipedia] “The photo of the water striders also illustrates the notion of surface tension being like having an elastic film over the surface of the liquid. In the surface depressions at their feet it is easy to see that the reaction of that imagined elastic film is exactly countering the weight of the insects.” [Wikipedia]

The effects of surface tension are reduced by the water loving cotton. The reduction of the surface tension of the water enhances evaporation. The surface of the cotton fibres is a mixture of water and fibres. The energy of the sunlight hitting the small bits of water on the fibres will be more efficiently be converted into energy for evaporation. Reduction of the size of the water units makes evaporation easier. Since the water is evaporated before it falls off the bottom of the evaporation cloth, the amount of water on the primary evaporation cloth [8] is minimal, the primary evaporating cloth [8] is damp to touch. This damp primary evaporation cloth [8] will facilitate evaporation when compared to pool evaporation. The suns energy or the energy in the wind is transferred better when it occurs between a fibre of damp cotton and the air than between the air and a pool of standing water. The surface tension of pool water is stronger than the surface tension of water on a damp towel. When water beads on a clean waxed car, the strength of the surface tension will draw the water into a bead, this drop of water will rise in height and assume a position of least surface area. For an water molecule to evaporate it has to escape these forces. Water droplets on cotton will disappear, they will be absorbed into the cotton. Light will evaporate water more effectively when it is absorbed in cotton on a damp primary evaporation cloth [8] than when in a horizontal pond. The huge mass of the water in a pool takes large amounts of the sunlight's energy heating it up The surface of these cotton fibres is a mixture of cotton and water. Significant quantities of this salt water is inside the cotton fibre. The cotton will also hold more water for a short period of time without dripping off the bottom of the evaporating cloths. A pail of water [12 litres] has remained undisturbed near my desalinators for a year. A copious snow fall and 6 inches of spring rain filled the pail to ⅔ full. The water level has risen as a result of rain. The pail has more water in it in September than it had in the spring. The evaporation from the pail was less than the amount of rain fall. Some of the sunlight did not reach the water in the pail. A single desalinator can desalinate a pail of water of this size daily [2 beach towels—total 200 cm×200 cm]. The latent heat of evaporation for water is 2257 KJ/Kg [970 Btu/lb] of water. This is a lot of energy and it takes a while for it to be accumulated from the environment. The latent heat of evaporation for water is the higher than for all other substances. These desalinators work 24 hours a day. The evaporation rate from the cloths will fall as the humidity rises to its saturation point. Sunlight destroys the dyes that are in the beach towels that are available. Black would be the best colour for the primary evaporation cloth [8].

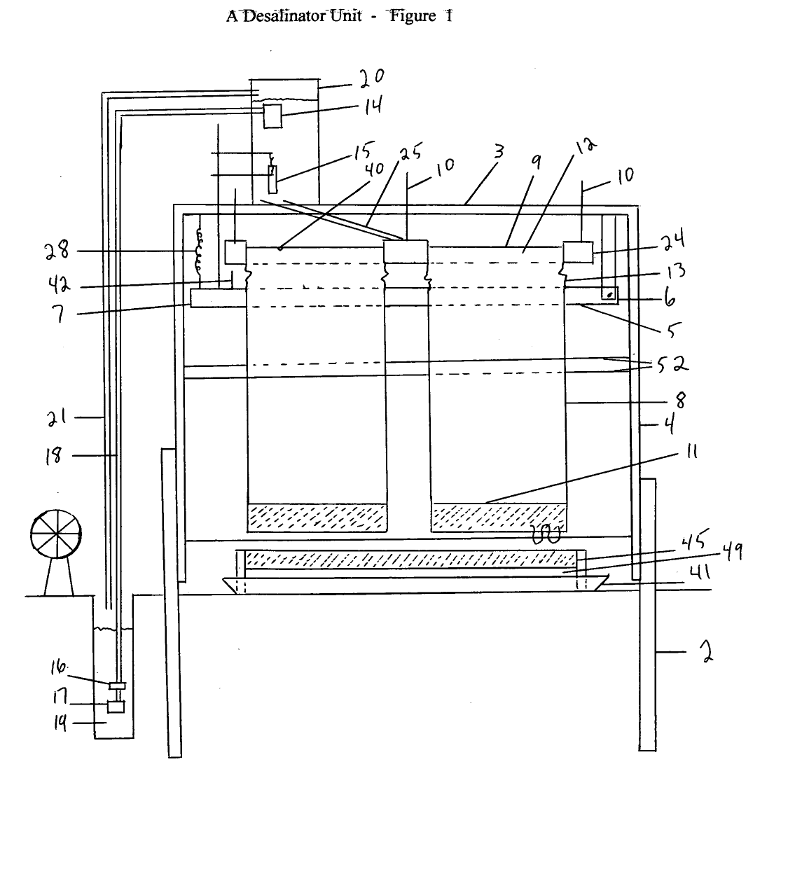

As depicted in FIG. 1, there is provided a means for drawing water from the soil to the primary evaporation cloth [8]. As shown in FIG. 1, in one embodiment the means comprises a filter [14] to prevent solid particles from plugging valves [15], a foot valve [16] protruding below the water table, an associated pump [17] and riser pipe [18] for carrying the salty water [19] from the pump [17] to the reservoir [20] and an overflow pipe [21] which will return surplus salty water to its source if the reservoir [20] should have surplus salty water.

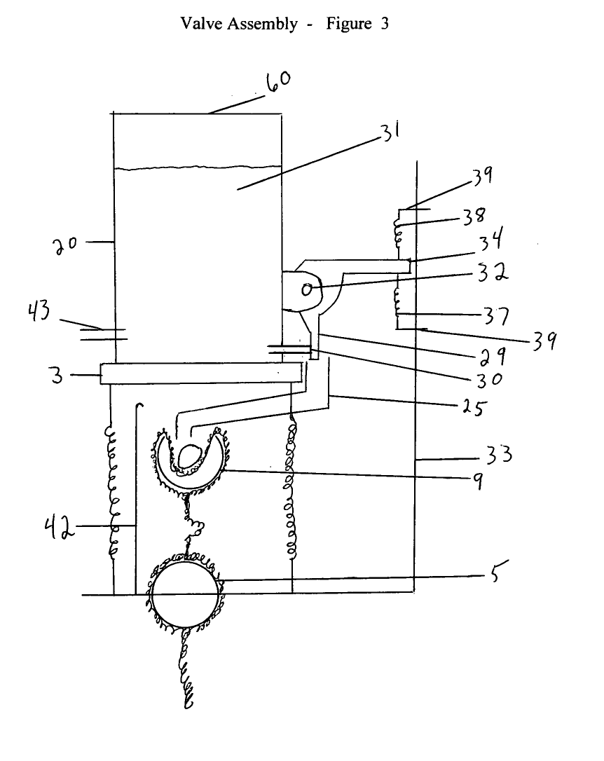

The surface tension of water makes it difficult to spread small amounts of water evenly across the primary evaporation cloth [8]. This problem is overcome by the development of a wicking system which feeds water to the primary evaporation cloth [8]. According to FIG. [2] a rod or pipe [22] is placed inside and suspended in a trough [23]. The trough [23] is sealed at both ends [24] and these seals [24] are used for the placement of the rod or pipe [22]. One embodiment of the distribution pipe [9] has it made from 2 inch plastic DVW plumbing pipe. The DVW pipe has the top part of it cut out to make it a trough [23], the ends and the middle of the DVW pipe are left intact for installation of the pipe or rod [22], the suspension members [10] of the distribution pipe [9] and the placement of the transfer pipe [25]. The suspension members [10] are made of threaded rod with nuts securing distribution pipe [9] and its positioning under the frame [3] with nuts on top of the frame [3]. Plumbing fittings [24] are used to seal the end of the distribution pipe [9] and suspend the rod or pipe [22]. Different materials may require different attachment details. The distribution pipe [9] has adjustments [10] where it attaches to the frame [3] so that it can attain be adjusted in its horizontal plane. When in this position an distribution pipe evaporation cloth [12] is threaded between the trough [23] and the rod [22]. The distribution pipe evaporation cloth [12] is then joined so that it surrounds the trough [23]. The rod [22] and the trough [23] are horizontal so that water from the reservoir [20] accumulates in the bottom of the trough [23] until the level of the salty water in the trough [26] reaches the cloth [12] at the bottom of the rod [22]. The salty water in the trough [26] then wicks up the distribution pipe evaporation cloth [12] until it emerges from the trough [23] and proceeds around the trough [23] and down onto a connecting evaporation cloth [13], which connects the distribution pipe evaporation cloth [12] and the primary evaporation cloth [8]. It has to be a loose connection which will allow the unrestricted movement of the cross beam [5]. As the level of the salty water [26] rises on the distribution pipe evaporation cloth [12] in the trough [23], the rate of water wicking out of the trough [23] will increase. This is the wicking distance [27] and the shorter it is the more salty water [26] will be deposited by capillary action, capillarity, capillary motion, or wicking on the primary evaporation cloth [8]. This will enable the regulation of the flow rate to the primary evaporation cloth [8] in order to deal with the differences in the evaporation rates of day and night. In extreme evaporation temperatures a doubling of towel material in the distribution pipe evaporation cloth may be required to get sufficient salty water onto the primary evaporation cloth [8]. Variations in the evaporation rates of sunshine or cloud can be handled by this system. Temperature variations will make for different rates of evaporation. The different evaporation rates of differences in latitude can be handled by this system. When the water on the primary evaporation cloth [8] evaporates, the primary evaporating cloths [8] get lighter the spring or springs [28] that are attached to second end [7] of the cross beam [5] contract and the flap valve [15] [FIG. 3] opens putting water into the distribution pipe [9] via the transfer pipe [25]. The flow rate through the flap valve [15] is slow enough so that the water drips when first opened. There is a delayed reaction time between the flap valve [15] opening, the distribution pipe [9] filling and the salty water wicking down on the primary evaporation cloth [8] stretching the spring [28] to shut off the valve. A slow flow rate will deal with this situation. Temperature and sunlight variations are generally not sudden. At peak evaporation times the valve [15] should be dripping or at a slow flow all the time. As the flap [29] moves away from the hole in the valve [30] the surface tension of the salty water [31] restricts the passage of salty water through the valve [15]. The material of the valve [ 15] and flap [29] will affect the surface tension of the water as it passes through the valve [15] and influence the flow rate through the valve [15]. The body of the valve [15] this inventor uses is made of plastic and the flap [29] is made of rubber. The flap [29] pivots on an axel [32] mounted above the valve hole [30]. As the water on the primary evaporation cloth [8] evaporates and gets lighter the connection rod [33] will raise the flap valve arm [34] pulling the flap [29] away from the hole in the valve [30]. As the water on the primary evaporation cloth [8] gets heavier and stretches the spring [28] the cross beam [5] pivots on its first end [6] lowering the second end [7] and closing the flap [29] on the hole [30] causing the flow to slow or stop. The flap [29] closes on a sharpened pipe with a hole [30] diameter of 1/16 of an inch. The size of the primary evaporation cloths [8] that is appropriate for this valve [15] is 200 cm×200 cm. The level of salt was low in the water used. The depth of the water [31] in the reservoir [20] determines the pressure that pushes the water through the valve [15]. This is a low pressure flap valve [15], so the surface tension of the water will influence the performance of the valve [15]. The surface tension of the salt water will be influenced by the level of salt in the water. The greater the level of salt in the water, the higher the strength of the surface tension. The size of the hole [30] in the valve [15] can be used as an adjustment to deal with different valve materials and changes in the surface tension due changes in the amount of salt in the water. A better exchange of energy between the environment and the evaporation cloths will occur when energy from the environment be it sunshine or wind engages with the moist cotton fibres on an evaporation cloth than with a pool of standing water; A growth of algae can occur on the valve [15], causing it to plug or restrict the rate of flow. An algaecide [35] can be added to the primary reservoir [36] as shown in FIG. [4] to stop this growth.

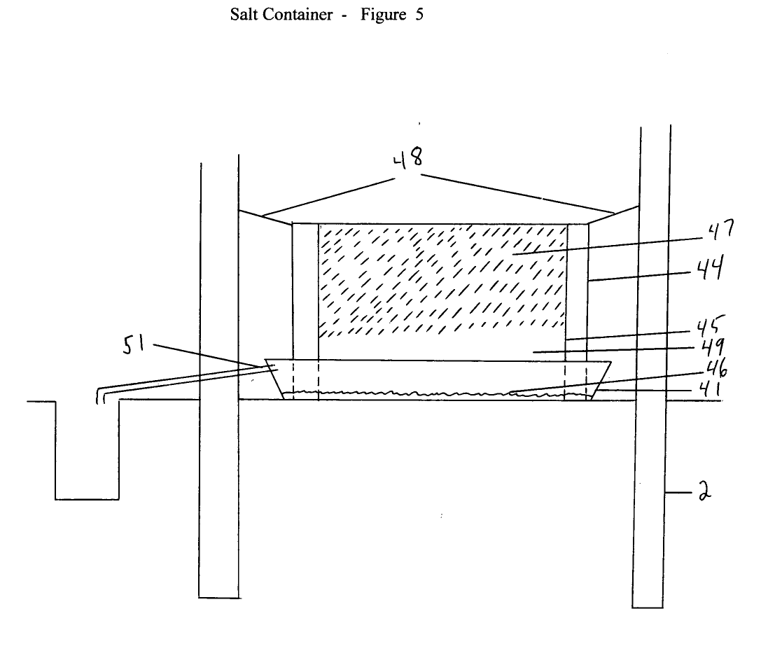

The second end of the cross beam is attached to the frame with a spring [28], so when the primary evaporation cloth [8] is wet and the flap valve [15]is closed the weight of the primary evaporation cloth [8] will be on the valve. If the weight of the primary evaporation cloth [8] is allowed to fall on the flap valve arm [34], then harm could come to the flap valve [15]. This means that the connection rod [32] has to have flexibility in its attachment to the flap valve arm [34]. One embodiment has the connection rod [32] attached to the flap valve arm [34] with a lower spring [37] and an upper spring [38] attached to the flap valve arm [34] and two members [39], attached to the connection rod [32]. The connection rod [32] is threaded to enabling the members [39] to move up and down the connection rod [32] thus allowing for the adjustment of valve [15] opening to determine the weight of the water on the primary evaporation cloth [8]. The flap valve arm [34] is designed so that it can move high enough so the valve [15] can be cleaned without detachment. The mounting adjustments [10] of the distribution pipe [9] are used to adjust the uniformity of the salt water that is wicked on to the primary evaporation cloth [8]. If the bottom of one side of the primary evaporation cloth [8] is dry and shows the appearance of salt higher on the primary evaporation cloth [8] and the other side is wet, then not enough water has been wicked on the dry side. The adjustment can be made by lowering the distribution pipe [9] and reducing the wicking distance [27] above the dry side of the primary evaporation cloth [8] or raising the end of the distribution pipe [9] and increasing the wicking distance [27] that is above the side of the primary evaporation cloth [8] that is wet. If the middle of the primary evaporation cloth [8] is dry then its adjustment could be lowered or if it is wet the centre of the distribution pipe [9] could be raised. Additional means to attain a level line of crystallized salts [11] on the primary evaporation cloth [8] consists of a further use of the centre distribution pipe adjustment [10] and its extension in the distribution pipe. [9] to come into contact with the rod or pipe [22] in an adjustable fashion to allow for the correction of the forces of the weight of the distribution pipe evaporation cloth [12] to displace the rod or pipe [22] in the trough [23] from its uniform suspension in the trough [23]. Another means to equitability distribute the salt water to the primary evaporation cloth [8] is to remove parts of the distribution pipe evaporation cloth [12] that go under the rod [22] closest to the point where the transfer pipe [25] empties into the distribution pipe [9]. This location may wick more water than the distribution pipe evaporation cloth [12] at the ends of the distribution pipe [8]. A trimming of the distribution pipe evaporation cloth [12] in the trough [23] under the rod or pipe [22] near where the transfer pipe [25] empties into the trough [23] maybe required to adjust the uniformity of the salt water [26] that is wicked on to the primary evaporation cloth [8]. An overflow outlet [40] is installed on the end of the trough [23] that is above the second end [7] of the cross beam [5], then if the distribution pipe [9] should flood the overflow would run down the evaporation cloth [8] on the second end of the cross beam [5]. This added weight will close or slow the flow of water through the flapper valve [15] and stop or reduce the flow of water into the distribution pipe [9] until an adjustment of the valve [15] has been made. If the reservoir [20] should empty of water and the primary evaporation cloth [8] should dry up, then an initial overflow of water will occur until the primary evaporation cloth [8] is wet enough to close the valve [15]. Small overflows of about five hundred mls water in this situation are of no consequence since it will fall in the salt container [41] [FIG. 5] and be evaporated. A periodic flooding of the trough [23] and primary evaporation cloth [8] could be used to wash the salts into the salt container [41] if the overflow outlet [40] were closed. The second end of the cross beam [5] can be elevated by a temporary connecting arm [42] [FIG. 3] until sufficient water has been added to the distribution pipe [9] and primary evaporation cloth [8] to wash the salts [11] off the evaporation cloth [8] into the salt container [41]. The accumulation of salts [11] at the bottom of the primary evaporation cloth [8] will replace a similar weight of water on the primary evaporation cloth [8], thus reducing its capacity. Regular washing of the salts [11] into the salt container [41] may be necessary depending on the salts [11] or dissolved substances [11] involved. A hose [43] attached to a reservoir [20] could supply water for hand applying the water for the washing of salts [11] into the salt container [41]. The individual characteristics of each different salt [11] or combination of salts [11] or dissolved substance [11] or carried substance [11] will perform differently on the bottom of the primary evaporation cloth [8]. Crystallized salts [11] will be washed off with the flooding of the primary evaporation cloth [8]. This water can be evaporated before the next flooding or wash off. The salt container [41] [FIG. 5] has adaptations which gives it an ability to deal with rainfall or its flooding and the capture of the salts in a movable form. A frame [44] is constructed over the salt container [41] [FIG. 5]. A secondary evaporation cloth [45] is suspended from the frame [44] over the salt container [41] and allowed to touch the bottom of the salt container [41]. The function of the secondary evaporation cloth [45] is to wick water up the secondary evaporation cloth [45], evaporate the water [46] and deposit the salts [47] or other substances [47]. The frame [44] has restraints [48] which prevent the secondary evaporation cloth [45] from displacement from the forces of the wind. The salt [47] in this situation is deposited on the top of the secondary evaporation cloth [45]. There is a wet area [49] at the bottom of these secondary evaporation cloths [45] as long as they touch salty water [46]. These secondary evaporation cloths [45] can be used as the harvesting point for salt removal. They should be installed with salt water [46] in the salt container [41] as the salt water [46] and deposits of crystallized salts [47] will add to the structure of the secondary evaporation cloth [45]. Newspapers can be used as an secondary evaporation cloth [45]. The newspapers could be harvested every couple of months, transported in tote boxes with lids to the appropriate disposal sites. The individual characteristics of each different salt [47] or combination of salts [47] or dissolved substance [47] or carried substance [47] will perform differently on the secondary evaporation cloth [45], some will form hard crystal structures, some might fall back into the salt container [41]. Wind is significant problem that has to be dealt with in all the construction of the apparatus. The reservoirs have to be secured, the posts have to be in the ground far enough to resist the wind which turns the primary evaporation cloths [8] into sails and the frame moving the posts from their upright stature. The frame has to be able to handle the forces of the wind.

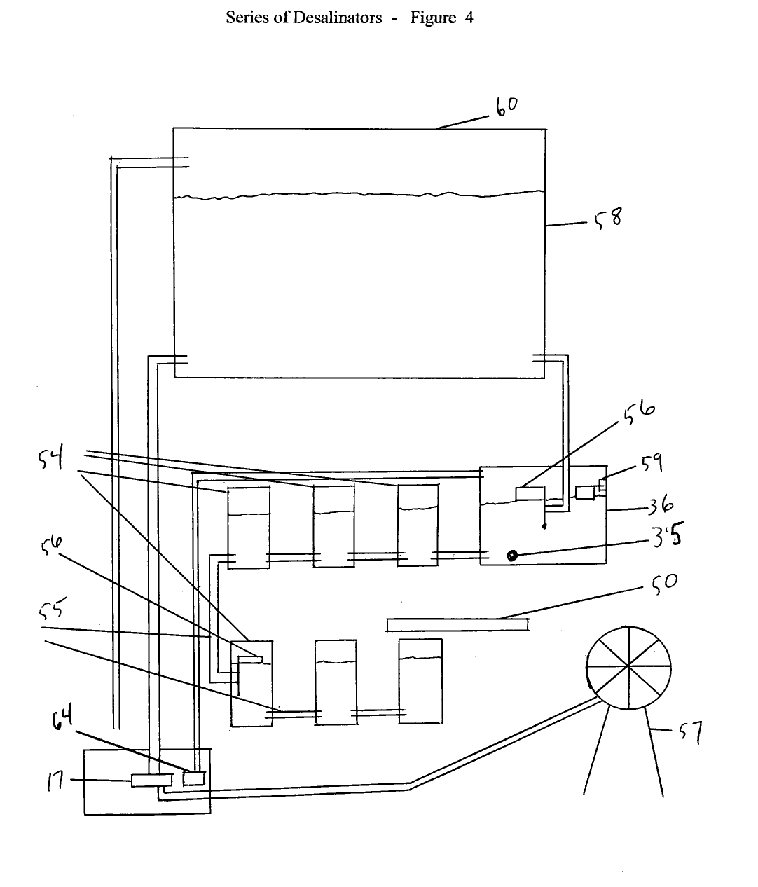

The amount of rainfall in a particular area would play a part in the decision as to whether a roof [50] [FIG. 4] is necessary or if the secondary evaporation cloth [45] can evaporate the water in the salt container [41]. A second set of secondary evaporation cloths [45] could be installed in the salt container [41] which would increase its ability to evaporate rain water and or salty wash water [46]. The depth of the salt container [41] will give capacity to deal with rainfalls or periods of wet weather. The beach towel material that this inventors uses will wick water to a vertical height of 10 inches [24 cm]. Thicker cloths will wick higher. Secondary evaporation cloths [45] made from discarded newspapers will work well as removable secondary evaporation cloths [45] as long as they are replaced before they fall apart. Newspapers will wick water to the height of their natural fold. Crystal growth will occur on the top and sides newspapers. The newspaper is hung on the frame [44]. If the salt container [41] can hold water to a depth of 6 inches, a significant capacity will be established which can by time for the secondary evaporation cloth [45] to evaporate the salty water. Extreme weather events and equipment malfunction happen and overflows will occur. An over flow outlet [51] is installed at the top of the salt container [41] which would drain water back to the source of the salt water [19]. The salt containers [41] will have to deal with the wind. They can be weighted with rocks or tied to the ground or installed in the ground. The primary evaporation cloths [8] could adjusted to be flooding enough to keep water in the salt container [41] to keep it in its place. They could be physically configured in such a way to avoid the grasp of the wind. The primary evaporation cloth [8] has ropes [52] [FIG. 1] or other means to keep them from flapping in the wind. One embodiment has ropes [52] strung from side to side attached to the frame and on both sides of the primary evaporation cloth [8]. The bottom of the primary evaporation cloth [8] has to be restrained so a series of loose loops [53] tied to the bottom rope [52] and the bottom of the primary evaporation cloth [8] will provide the restraint required and the freedom required to allow the cross beam [5] to move from its upper dry position to its lower wet position and its lower wet position to its upper dry position.

A series of these desalinators [FIG. 4] would increase the volume of water desalinated. When a series of desalinators [1] FIG. [4] are used, then a primary reservoir [36] can distribute salty water to series of reservoirs [54] [20] located on each unit [1]. The reservoirs [54] are connected with pipes or hoses [55]. The primary reservoir [36] is where the algaecide [35] would be added. The water level in the reservoirs [54] at a lower elevation are controlled with float valves [56]. If a particular location does not have electrical power then wind power [57] can be used. If wind power [57] is used then a large reservoir [58] would be required to deal with times of no wind. Human power could be used to fill the reservoirs [20]. The windmill that this inventor uses produces compressed air. The compressed air powers a displacement pump [17] which pushes water into the large reservoir [58]. The large reservoir [58] has an overflow [21] [FIG. 4] which sends the surplus water back to the source of the salty water as this pump has no “on off” function. Compressed air could be used to replace the spring and detect the weight of the primary evaporation cloth [8] to open the valve [15] to the distribution pipe.

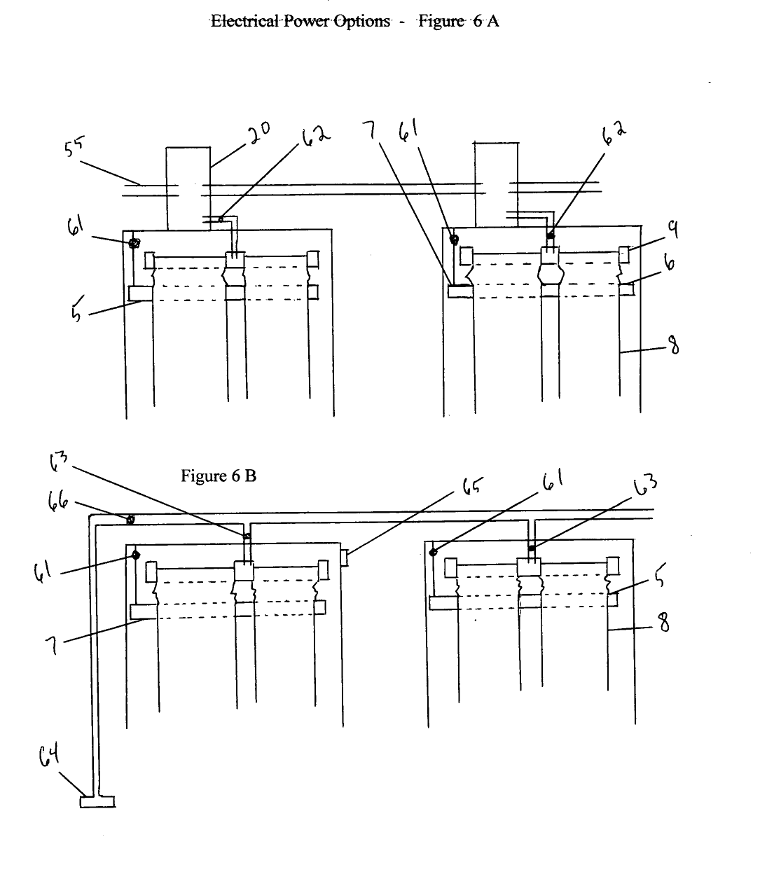

If electrical power is used to fill the primary reservoir [36], then a switch [59] in the reservoir [FIG. 4] can be used to control the level of water in the primary reservoir [36]. All reservoirs [20] [54] [36] [58] are covered with lids [60] in order to prevent wind blown refuse from getting into the reservoirs [20] [36] [54] [58] and plugging the valves [15] [56]. Periodic cleaning of the reservoirs [20] will be required in some circumstances as the algaecide [35] may leave a residue of its activity which may foul the valves [15] [56]. A periodic cleaning of the reservoirs maybe required depending on the water used. The controlling of the amount of water on the primary evaporation cloths [8] can be done with weight sensors [61] [FIG. 6A] which can open an electronic valve [62] to various flow rates depending on the evaporation rates of the primary evaporation cloths [8]. The controlling of the amount of water to the distribution pipe [8]—[FIG. 6B] could be done with a small electronic valve [63] with a pressurized water system [64] at the source of the salt water [19] pushing salty water through the small electronic valve [63] when a weight sensor [61] was triggered by the loss of the weight of the primary evaporation cloths [8]. Computer technology or electronic technology [65] could be used to control the salt water through the valves in conjunction with the flow volume gauges [66], weight sensors [61], wash cycles, or sunshine sensors [65] and or temperature sensors [65] which could make them [1] run more efficiently because they could more accurately put salt water on the primary evaporation cloth [8]. A volume sensor [67] in the salt container [41] could tell the computer if there was two much salty water in the salt container to permit the washing of the primary evaporation cloth [8].

1. An apparatus for the evaporation salty water and the capture of the dissolved salts or other dissolved chemicals or substances that may be carried by water, said apparatus comprising:
[a] two posts which have been installed in the ground or other attachments to the ground to which a frame has been attached which has vertical supports and a horizontal cross beam;
[b] an primary evaporation cloth attached to the cross beam;
[c] a distribution pipe for receiving salty water and depositing it evenly onto the primary evaporation cloth, the distribution pipe being attached to the frame in a position above the primary evaporation cloth;
[d] an vertically orientated primary evaporation cloth attached to the cross beam, the cross beam having a first end and a second end, wherein the first end of the cross beam is hingedly attached to the frame and the second end is suspended from the frame by an spring or an extendible member such that the cross beam is movable between an upper horizontal position and a lower angled position;
[e] means for drawing water from the pond or drainage system to the distribution pipe comprises a foot valve protruding below the water table, a filter to remove the particles that may plug a valve, a pump connected to the foot valve and a riser pipe for carrying water from the pump to the distribution pipe;
[f] a reservoir between the riser pipe and the distribution pipe, the reservoir being attached to the frame in a position above the distribution pipe and having an outlet to the distribution pipe and having an overflow pipe that caries water back to the foot valve if the reservoir becomes too full;
[g] the means to regulate the volume of water deposited to the primary evaporation cloth is comprised of a threaded connecting rod which the connects the flapper valve arm of the valve and the second end of the cross beam, its attachments to the flapper valve arm can be adjusted so that the valve mechanism opens allowing water to flow into the distribution pipe when the primary evaporation cloth is dry and light and the spring or springs have raised the cross beam, and which closes stopping the water flow into the distribution pipe when the primary evaporation cloth is wet and heavy and has stretched the spring or springs of the second end of the cross beam;
[h] a valve mechanism is comprised of a flap that is attached to the flapper valve arm and which the flap pivots on the valve axel from above a small hole in the valve which has been mounted on the side of the reservoir so that when the cross beam is in its upper, horizontal, dry and light, position the flap has moved away from the hole in the valve and when the cross beam is in its lower angled wet and heavy position the flap has closed on the hole in the valve;
[i] a means to adjust the rate of flow from the hole in the reservoir is made by adjusting size of the hole in the valve so that the interaction of the surface tension of the water, the material of the valve, the amount of salt in the water and the movement of the primary evaporation cloth produces a small flow of water not much greater than the highest evaporation rate of the primary evaporation cloth;
[j] an addition of an algaecide to the salty water in the reservoir to prevent the plugging of the small hole in the valve if algae growth should occur;
[k] a transfer pipe which takes the salty water from the valve on the reservoir and moves it into the distribution pipe;
[l] a distribution pipe for receiving ground water and depositing it evenly across the primary evaporation cloth, the distribution pipe being attached to the frame in a position above the primary evaporation cloth, the distribution pipe is comprised of a rod or pipe that is placed inside and suspended uniformly in a trough which has an distribution pipe evaporation cloth threaded between the pipe and the trough and encircling the trough which is sealed at both ends so it will hold water when placed horizontally, the distribution pipe evaporation cloth in the trough makes a u shape when inside the trough, wherein the trough, rod and cloth in the trough are as long as the primary evaporation cloth, and the salty water from the reservoir by means of the transfer pipe accumulates in the bottom of the trough until the level of the salty water reaches the cloth at the bottom of the rod, the salty water then wicks up the distribution pipe evaporation cloth until it emerges from the trough and proceeds around the trough and down onto the primary evaporation cloth achieving an equitable distribution of salty water to the primary evaporation cloth;
[m] the ability to deposit the salty water at various rates on the primary evaporation cloth is achieved by using the level of the salty water in the distribution pipe, as the water rises on the cloth in the trough, the distance that the water has to wick up the cloth to the top of the trough is reduced, this reduction of wicking distance produces a higher rate of water which can be deposited on the primary evaporation cloth, which will enable the variation of the flow rate to the primary evaporation cloth in order to deal with the differences in the evaporation rates of day or night or sunshine or cloud or temperature;
[n] the evaporation of the salty water before it falls off the primary evaporation cloth and the carrying of the salts by the water to the bottom of the primary evaporation cloth where a line of salt crystal growth occurs or other deposits of dissolved minerals or deposits of carried substances or the depositing of the other substances when the last of the water is evaporated;
[o] the evaporation cloths be made from water loving materials such as cotton or wool or plant fibres that will readily wick and hold water and allow for the reduction of the surface tension of water as compared with pools of standing water;
[p] a set of distribution pipe adjustments which attains the equitable distribution of salty water to the primary evaporation cloth, one embodiment composed of the three suspension rods of the distribution pipe which are threaded with nuts on top of the frame allowing for the raising or lowering of the distribution pipe at its ends and at its middle, so that if the appearance of the salt crystallization materializes higher on a side of the primary evaporation cloth, then the suspension rod that supports that side of the distribution pipe be lengthened so to allow the depth of the salt water in the distribution pipe to increase which allows for the shortening of the wicking distance that the salty water has to wick up the distribution pipe evaporation cloth in the trough in order to escape the trough and to descend down onto the primary evaporation cloth to be evaporated, or if the appearance of the salt crystallization is lower in middle of the primary evaporation cloth then the centre suspension rod could raise the centre of the distribution pipe and lengthen its wicking distance or the suspension rods at the ends of the distribution pipe could be lowered so that the wicking distance is reduced at the ends of the distribution pipe evaporation cloth or additional means to attain a level line of crystallized salts on the primary evaporation cloth consists of a further use of the centre distribution pipe suspension rod to come into contact with the rod or pipe in an adjustable fashion to allow for the correction of the forces of the weight of the distribution pipe evaporation cloth to displace the rod or pipe in the trough from its uniform suspension in the trough or a trimming and removal of some of the distribution pipe evaporation cloth that goes under the rod or pipe and wicks salt water out of the trough closest to the point where the water from the transfer pipe enters the trough because it may wick more water than the distribution pipe evaporation cloth at the ends of the trough;
[q] a connecting evaporation cloth connects the distribution pipe evaporation cloth at the bottom of the distribution pipe and the primary evaporation cloth on the top of the cross beam, this transmits the water from the distribution pipe evaporation cloth to the primary evaporation cloth without the loss of salt water if it were to drip and splash, this cloth has extra length between the distribution pipe and the cross beam so that the cross beam can move between its upper and lower positions;
[r] an addition of energy from the environment or the gathering of energy from the environment or the harvesting of environmental energy either from sunshine or direct contact of the air molecules or the wind carrying the cold air away from all of the evaporation cloths or the cooling of the air next to the evaporation cloths and its falling below the evaporation cloths to be replaced by warmer air or insects drinking or other radiation or other means to provide energy for the evaporation of the salty water;
[s] the small amount of salty water on each fibre of evaporation cloth enhances evaporation of water because of their reduced mass as compared to pools of standing water;
[t] a better exchange of energy will occur when energy from the environment be it sunshine or wind engages with a moist cotton fibre than with pool of standing water;
[u] a series of ropes or other members which extends from one side of the frame to the other side of the frame and on both sides of the primary evaporation cloth and tied to the bottom of the primary evaporation cloth to prevent the primary evaporation cloth from flapping in the wind, and said ropes are loose enough to allow the cross beam to move between its upper and lower positions;
[v] a temporary connecting arm which will lift the cross beam into its upper position opening the valve which would allow the distribution pipe to put excess salty water onto the primary evaporation cloth and wash the salts off the bottom of the primary evaporation cloth into the salt container, when this has been achieved or will be achieved the temporary connecting arm would be disconnected and the cross beam would return to it normal function or a hose attached to a reservoir or a source of water which could wet the primary evaporation cloth enough to rinse the salts off the primary evaporation cloth and into the salt container;
[w] a salt container positioned below the primary evaporation cloth to hold the salt water that has been used to wash the crystallized salts off the primary evaporation cloth or to hold the salt crystals or dissolved substances or carried substances that fall off the primary evaporation cloth;
[x] a frame which spans the salt container which has an secondary evaporation cloth suspended from the frame to the bottom of the salt container and the secondary evaporation cloth is contacting the salt water at the bottom of the salt container;
[y] a secondary evaporation cloth which is attached to the bottom of the salt container or otherwise restrained in order to prevent the wind from blowing them away;
[z] the function of the secondary evaporation cloth is to wick the salt water up the secondary evaporation cloth to a sufficient height so that when the salt water wicks up the secondary evaporation cloth it brings the salts with the water which evaporates leaving the salts to crystallized or other substances to deposit at the top of the secondary evaporation cloth with a wet area of evaporating salty water below the crystallized salts as long as there is salty water in the salt container;
[aa] the periodic removal of the secondary evaporation cloth with the crystallized salt or other substances and the transporting of them to an appropriate landfill, or the removal of the secondary evaporation cloth and its cleansing of the salts and returned to its position in the salt container and the salts taken to an appropriate landfill;
[ab] a roof over the primary evaporation cloth and the salt container to prevent the salt container from flooding if the rainfall in an particular area is so great that it exceeds the ability of the secondary evaporation cloth to evaporate the rainfall and the rinsing water;
[ac] and lids on the reservoirs to keep wind blown refuse from getting in the reservoirs and plugging the valves.

2. The apparatus of claim 1 wherein a series of desalinators are constructed with the primary reservoir receiving the salty water from the pond or drainage system first and then distributing the water via hoses or pipes to other reservoirs in a series of desalinators at the same elevation or others at a lower elevation the water level being controlled by float valves.

3. The apparatus of claim 1 wherein the pump is a electrical pump which is wired to an adjustable switch mechanism that is attached to the primary reservoir which activates the switch and turns on the pump when the water level is low in the primary reservoir and deactivates the switch and turns off the pump when the primary reservoir is full of water.

4. The apparatus of claim 1 wherein the controlling of the salty water to the distribution pipe is done with weight sensors on the second end of the cross beam which opens a small valve which allows the flow of salt water into the distribution pipe when the primary evaporation cloth is dry and light and when the primary evaporation cloth is wet and heavy the weight sensor closes the valve.

5. The apparatus of claim 1 wherein the controlling of the variability of the rate of salty water depositing on the primary evaporation cloth is achieved by the characteristics of different heights of the wicking distance or the depth of the water in the trough, the shortening of the wicking distance or an increase of the depth of salt water in the trough will increase the rate of salt water that will be wicked out of the trough and down onto the primary evaporation cloth, the increasing of the wicking distance or a decrease in the depth of salt water in the trough will reduce the amount of water wicking out of the trough and down onto the primary evaporation cloth.

6. The apparatus of claim 1 wherein the pump is a wind powered pump with a surplus capacity large reservoir with a enough capacity to supply the desalinators with salty water in periods of no wind, which would be installed above the primary reservoir and connected to the primary reservoir with a hose and float valve controlling the flow of salty water into the primary reservoir.

7. The apparatus of claim 1 wherein the pump is a pressure water system which maintains pressured salty water up to the valve above the distribution pipe which is opened and closed by an weight sensors allowing salty water into the distribution pipe when a loss of salty water on the primary evaporation cloth triggers the weight sensor on the second end of the cross beam to tell the valve to open and when sufficient salty water has been placed on the primary evaporation cloth the weight sensors triggers the close of the valve or computer or electronic technology controlling the opening of the valve for the rinsing of the primary evaporation cloth and a sensor in the salt container to tell the computer if there was to much salt water in the salt container to permit a rinsing of the primary evaporation cloth, or computer or electronic technology with or without temperature sensors and with or without sunlight sensors and with or without a clock along with the weight sensors of the second end of the cross beam to control the opening of the valve and the placement of salty water on to the primary evaporation cloth.

8. The apparatus of claim 1 where the use of water loving fibres such cotton or wool or other fibres or products in the material for the evaporation cloths because they provide a surface that absorbs the salty water which weakens the surface tension and provides for the division and the diffusion of the water drops into smaller units and the absorption of the water into the fibres and the fibres to have a nature of equalizing the amount of water that each fibre or bunches of fibre holds and providing a surface of water soaked cotton or wool or plant fibres or other water loving substances and intermingled with smaller units of water making the energy of the sunlight and other sources more efficient for the evaporation of salty water than pools of standing water.

9. The apparatus of claim 1 where the salty water is added to the distribution pipe, the distribution pipe evaporation cloth wicks the salty water to the connecting evaporation cloth and the connecting evaporation cloth wicks the salty water to the primary evaporation cloth and the salty water is evaporated before it falls off primary evaporation cloth, the evaporation of the salty water is enhanced by the relatively small volumes of water on the individual fibres of the evaporation cloth as compared to pools of standing water.

10. The apparatus of claim 1 wherin as the salty water is added to the top of the evaporation cloth from the distribution pipe, it passes down the primary evaporation cloth and is evaporated before falling off the primary evaporation cloth, this minimizes the mass of the salt water on the primary evaporation cloth and reduces the effects of the surface tension of water which enhances evaporation as compared to pools of standing water.

11. The apparatus of claim 1 wherin the distribution pipe has the ability to distribute salty water evenly over the length of the primary evaporation cloth.

12. The apparatus of claim 1 wherin the distribution pipe has the ability to deposit salty water at various rates on the primary evaporation cloth with the used of different wicking distances in the distribution pipe, empowering these desalinators to deal with the various the rates of evaporation that may occur in a day or night or hot or cold or sunny or cloudy.

13. The apparatus of claim 1 has the ability to stop the flow of salty water to the primary evaporation cloth if evaporation rates should slow or stop.

14. The apparatus of claim 1 has the ability to capture salts from the salt water in the salt container with the use of a secondary evaporation cloth which is suspended vertically in the salt container touching its bottom and wicking the salt water up the cloth until the water evaporates and the salts or other substances are deposited on the top of the secondary evaporation cloth.

15. The apparatus of claim 1 wherin the capture of salts or dissolved substances on an recycled product such as a discarded newspaper or plant fibre or other water loving substances or water wicking substances.

16. The apparatus of claim 1 wherin the capture of salts on an easily transportable form such as the salts being deposited on newspapers and these salty newspapers be put in covered boxes and taken to an appropriate landfill.

17. The apparatus of claim 1 wherin a natural flow of energy to the evaporation cloth due to its being colder than its environment because of its constant evaporation, this creates a layer of cold air which falls off the evaporation cloth which will be replaced by warmer air thus enhancing evaporation.

18. The apparatus of claim 1 wherin a better exchange of energy between the environment and the evaporation cloths will occur when energy from the environment be it sunshine or wind engages with the moist cotton fibres on an evaporation cloth than with a pool of standing water;
